(19) United States
(12) Patent Application Publication
(10) Pub. No.: US 2026/0365839 A1
(43) Pub. Date: Nov. 19, 2026

(54) POLYPROPYLENE COMPOSITION AND MOLDED ARTICLE

(71) Applicant: TOYODA GOSEI CO., LTD., Kiyosu-shi (JP)

(72) Inventors: Emiko KURIMOTO, Aichi (JP); Yasushi NIMI, Aichi (JP)

(21) Appl. No.: 19/670,107

(22) Filed: May 7, 2026

(30) Foreign Application Priority Data
May 13, 2025 (JP) 2025-080657
Dec. 4, 2025 (JP) 2025-231985

(51) Int. Cl. C08L 23/12; C08K 3/30; C08K 3/34

(52) U.S. Cl. CPC C08L 23/12; C08K 3/30; C08K 2003/3063; C08K 3/346; C08L 2205/025

(57) ABSTRACT

A polypropylene composition contains: a low-molecular-weight polypropylene which is a block polypropylene or a homo-polypropylene having a Mw of 200,000 to 380,000; a high-molecular-weight polypropylene which is a block polypropylene having a Mw of 400,000 to 700,000 or a homo-polypropylene having a Mw of 500,000 to 700,000; and at least one rubber selected from a rubber component copolymerized with the low-molecular-weight polypropylene, a rubber component copolymerized with the high-molecular-weight polypropylene, and a post-added rubber.

### CROSS-REFERENCE TO RELATED APPLICATION

This application is based on and claims priority under 35 USC 119 from Japanese Patent Application No. 2025-080657 filed on May 13, 2025 and Japanese Patent Application No. 2025-231985 filed on Dec. 4, 2025.

### TECHNICAL FIELD

The present invention relates to a polypropylene composition.

### BACKGROUND ART

Polypropylene compositions used for molding interior and exterior parts of automobiles and the like are required to have rigidity, impact resistance, scratch resistance, and the like.

Patent Literature 1 describes a polypropylene resin composition containing 75 weight % to 95 weight % of a low-molecular-weight polypropylene having an intrinsic viscosity of 0.6 dl/g to 1.6 dl/g and 5 weight % to 25 weight % of a high-molecular-weight polypropylene having an intrinsic viscosity of 6 dl/g to 11 dl/g. The blending of the high-molecular-weight polypropylene is said to increase rigidity and scratch resistance. In Examples 1 to 13, it is presumed that only homo-polypropylene was used as the high-molecular-weight polypropylene and the low-molecular-weight polypropylene (since no raw material ethylene is added according to the description of synthesis thereof), and flexural moduli thereof were 2710 MPa to 3077 MPa and pencil hardness thereof was F or H. Izod impact strengths thereof were 8 J/m to 21 J/m.

Note that although there is a description (paragraph 0031) that “the high-molecular-weight polypropylene or the low-molecular-weight polypropylene may be a propylene block copolymer such as a propylene-ethylene block copolymer, which is preferable because of excellent rigidity and impact resistance thereof”, there are no examples in which block polypropylene is used.

Patent Literature 2 describes a resin composition containing a polypropylene resin, an olefin elastomer, a talc having an aspect ratio of 35 to 60, fibrous magnesium sulfate having an average fiber length of 8 μm to 30 μm, and a metal soap in a predetermined blending amount. This composition is said to be able to achieve a high level of both rigidity and impact resistance.

In Examples 1 to 6, the flexural moduli were 2000 MPa to 2100 MPa, and the Charpy impact strengths were 9.0 kJ/m² to 9.8 kJ/m².
Patent Literature 1: JP2000-226478A
Patent Literature 2: JP2020-122102A

### SUMMARY

As in Patent Literature 1, the blending of the high-molecular-weight polypropylene increases the scratch resistance, which is thought to also increase hardness that correlates with the scratch resistance, and generally, as the hardness increases, the impact resistance decreases.

When the talc is blended in a specific particle size and content range as in Patent Literature 2, the rigidity and hardness are increased while maintaining the impact resistance as compared with when no talc is blended, but the scratch resistance tends to decrease.

In addition, when a post-added rubber is blended, the impact resistance increases, but the hardness and scratch resistance tend to decrease.

As described above, in the conventional art, although it was possible to achieve both rigidity and scratch resistance, or both rigidity and impact resistance, it was difficult to achieve both impact resistance and scratch resistance.

Therefore, an object of the present invention is to achieve both impact resistance and scratch resistance.
((1)) A polypropylene composition containing:
a low-molecular-weight polypropylene which is a block polypropylene or a homo-polypropylene having a Mw of 200,000 to 380,000;
a high-molecular-weight polypropylene which is a block polypropylene having a Mw of 400,000 to 700,000 or a homo-polypropylene having a Mw of 500,000 to 700,000; and
at least one rubber selected from a rubber component copolymerized with the low-molecular-weight polypropylene, a rubber component copolymerized with the high-molecular-weight polypropylene, and a post-added rubber.

The polypropylene composition may contain a filler containing talc.

### Functions

The low-molecular-weight polypropylene, which is a block polypropylene or a homo-polypropylene having a Mw of 200,000 to 380,000, is a base material and is easy to mold due to high fluidity thereof, but impact resistance and scratch resistance thereof are not good.

By blending the high-molecular-weight polypropylene, which is a block polypropylene having a Mw of 400,000 to 700,000 or a homo-polypropylene having a Mw of 500,000 to 700,000, the scratch resistance is improved.

By blending the at least one rubber selected from a rubber component copolymerized with the low-molecular-weight polypropylene, a rubber component copolymerized with the high-molecular-weight polypropylene, and a post-added rubber, the impact resistance is improved.

When the filler containing talc is blended, rigidity is further increased, but the talc will be exposed to a surface in scratching and is prone to whitening. However, the whitening is prevented by the high-molecular-weight polypropylene.

The above-mentioned functions work in a complementary manner, thereby achieving both impact resistance and scratch resistance.

Note that blending amounts of the low-molecular-weight polypropylene, the high-molecular-weight polypropylene, the rubber, and the filler are not particularly limited since the blending amounts vary depending on required levels of impact resistance and scratch resistance, which differ depending on applications. However, blending as in ((2)) below is preferred so that a good balance between the impact resistance and the scratch resistance can be achieved.
((2)) The polypropylene composition according to ((1)), in which
relative to 100 parts by mass of the low-molecular-weight polypropylene, a blending amount of the high-molecular-weight polypropylene is 6 parts by mass to 165 parts by mass, a blending amount of the rubber is 30 parts by mass to 70 parts by mass, and a blending amount of the filler is 0 part by mass to 40 parts by mass.
((3)) The polypropylene composition according to ((1)) or ((2)), in which
the filler contains talc and fibrous magnesium sulfate.
((4)) A polypropylene composition containing:
a polypropylene having a weight average molecular weight of 300,000 to 500,000;
a rubber; and
a filler containing at least talc, in which
the polypropylene composition has a Charpy impact strength (23 °C) of 20 kJ/m² or more and a whitening load (a load at which a test piece begins to whiten when a test force is applied to the test piece based on a linear force increasing method in JIS K7316:2013) of 4 N or more.
((5)) The polypropylene composition according to ((4)), which has a tensile modulus (23 °C) of 1800 MPa or more.
((6)) The polypropylene composition according to ((4)) or ((5)), which has a Rockwell hardness (23 °C, R scale) of 55 or more.
((7)) The polypropylene composition according to ((4)), ((5)), or ((6)), which has an MFR (230 °C, 21.2 N) of 5 g/10 min or more.
((8)) A polypropylene composition containing:
a polypropylene;
a rubber; and
a filler containing at least talc, in which
the polypropylene composition satisfies the following formula (1),

Y≥−55X+61.5 (1)
where X represents a measured content of the rubber/a content of the polypropylene (details will be described in the Examples below), and
Y represents a weight average molecular weight Mw [×10⁴] of the polypropylene.
((9)) A molded article made of the polypropylene composition according to any one of ((1)) to ((8)).

According to the present invention, it is possible to achieve both impact resistance and scratch resistance.

### BRIEF DESCRIPTION OF DRAWINGS

FIG. 1 is a diagram illustrating a method for measuring a whitening load; and

FIG. 2 is a graph plotting “a measured content of the rubber/a content of the polypropylene” and a weight average molecular weight Mw [×10⁴] of the polypropylene for Examples and Comparative Examples.

### DESCRIPTION OF EMBODIMENTS

### (1) Low-Molecular-Weight Polypropylene

A low-molecular-weight polypropylene has an Mw of 200,000 to 380,000 (preferably 250,000 to 350,000) as described above. If Mw is less than 200,000, rigidity will be low, and if Mw exceeds 380,000, fluidity will be low.

The low-molecular-weight polypropylene may be a block polypropylene or a homo-polypropylene as described above, but is preferably a block polypropylene.

### (2) High-Molecular-Weight Polypropylene

As described above, the high-molecular-weight polypropylene is a block polypropylene having a Mw of 400,000 to 700,000 (preferably 400,000 to 650,000), or a homo-polypropylene having a Mw of 500,000 to 700,000. This is because both the block polypropylene and the homo-polypropylene have the function of increasing scratch resistance.

A blending amount of the high-molecular-weight polypropylene is not particularly limited as described above, but is preferably 6 parts by mass to 165 parts by mass, and more preferably 10 parts by mass to 150 parts by mass, and still more preferably 10 parts by mass to 100 parts by mass (relative to 100 parts by mass of the low-molecular-weight polypropylene).

### (3) Rubber

As described above, the rubber is at least one (that is, any one, any two, or three) of a rubber component copolymerized with the low-molecular-weight polypropylene, a rubber component copolymerized with the high-molecular-weight polypropylene, and a post-added rubber.

The post-added rubber is not particularly limited, but a preferred example is an ethylene-α-olefin copolymer. Examples of the ethylene-α-olefin copolymer include ethylene-propylene copolymer (EPM), ethylene-butene copolymer (EBM), ethylene-octene copolymer (EOM), and ethylene-propylene-non-conjugated diene copolymer (EPDM).

A blending amount of the rubber is not particularly limited as described above, but is preferably 30 parts by mass to 70 parts by mass, and more preferably 35 parts by mass to 60 parts by mass (relative to 100 parts by mass of the low-molecular-weight polypropylene).

### (4) Filler

As described above, the filler contains talc, and preferably contains talc and fibrous magnesium sulfate. As mentioned above, talc increases impact resistance but is prone to whitening, and therefore, an amount of talc can be reduced by using the fibrous magnesium sulfate in combination, which is less susceptible to whitening. It is preferable that an amount of the fibrous magnesium sulfate is less than that of the talc.

A blending amount of the filler is not particularly limited as described above, but is preferably 0 part by mass to 40 parts by mass, and more preferably 10 parts by mass to 30 parts by mass (relative to 100 parts by mass of the low-molecular-weight polypropylene).

### (5) Other Additives

The polypropylene composition may contain other additives, such as those exemplified below.
Lubricant: by adding a higher fatty acid amide and a compatibilizer, surface friction resistance is reduced and scratch resistance is improved.

Examples of the higher fatty acid amide include erucic acid amide, stearic acid amide, oleamide, and ethylene bis-stearamide.

Examples of the compatibilizer include a copolymer of ethylene and at least one vinyl monomer, which has low affinity with the higher fatty acid amide. Specific examples thereof include ethylene-acrylic acid copolymer, ethylene-methyl acrylate copolymer, ethylene-methyl methacrylate copolymer, ethylene-ethyl acrylate copolymer, ethylene-isobutyl acrylate copolymer, ethylene-n-butyl acrylate copolymer, ethylene-2-ethylhexyl acrylate copolymer, ethylene-ethyl acrylate-maleic anhydride copolymer, ethylene-ethyl acrylate-glycidyl methacrylate copolymer, ethylene-glycidyl methacrylate copolymer, ethylene-vinyl acetate-glycidyl methacrylate copolymer, ethylene-vinyl acetate copolymer, or saponification products thereof.
Antioxidant
UV absorber

### (6) Physical Properties of Polypropylene Composition

Physical properties of the polypropylene composition are not particularly limited, but are preferably as follows.
Charpy impact strength (23 °C): preferably 20 kJ/m² or more, more preferably 25 kJ/m² or more, and most preferably 30 kJ/m² or more. An upper limit thereof is not particularly specified, but would be 55 kJ/m².
Whitening load: preferably 4 N or more, more preferably 4.4 N or more, and most preferably 5 N or more. An upper limit thereof is not particularly specified, but would be 10 N.
Tensile modulus (23 °C): preferably 1800 MPa or more, more preferably 2000 MPa or more, and most preferably 2070 MPa or more. An upper limit thereof is not particularly specified, but would be 2800 MPa.
Rockwell hardness (23 °C, R scale): preferably 55 or more, more preferably 57 or more, and most preferably 60 or more. An upper limit thereof is not particularly specified, but would be 80.
MFR (230 °C, 21.2 N): preferably 5 g/10 min or more, more preferably 6 g/10 min or more, and most preferably 8 g/10 min or more. An upper limit thereof is not particularly specified, but would be 30 g/10 min.

### (7) Molded Article

Applications of the molded article are not particularly limited, examples thereof include automobile exterior parts such as grilles, bumpers, and cowl louvers, and automobile interior parts such as instrument panels, consoles, trim, pillars, center clusters, and deck side trims.

### EXAMPLES

Polypropylene compositions of Examples 1 to 7 and Comparative Examples 1 to 4 having the formulations shown in Table 1 below (blending values are in parts by mass) were prepared, and molded articles were formed.

TABLE 1

| | | | | Example | Example | Example | Example | Example | Example |
|---|---|---|---|---|---|---|---|---|---|
| | | Mw [×10⁴] | MFR | 1 | 2 | 3 | 4 | 5 | 6 |
| Blending | Block PP-1 (rubber | 33 | 28 | 100 | 100 | 100 | 100 | 100 | 100 |
| (part by | component: 37%) | | | (37.0) | (37.0) | (37.0) | (37.0) | (37.0) | (37.0) |
| mass) | Block PP-2 (rubber | 59.3 | 2.5 | 87.0 | 53.6 | 52.6 | 30.3 | 13.2 | |
| | component: 15%) | | | (13.1) | (8.0) | (7.9) | (4.5) | (2.0) | |
| | Block PP-3 (rubber | Estimated as 43 | 9.5 | | | | | | 30.3 |
| | component: 21%) | | | | | | | | (6.4) |
| | Block PP-4 (rubber | 31.9 | 30 | | | | | | |
| | component: 11%) | | | | | | | | |
| | Homo-PP-1 | Estimated as 60 | 1.9 | | | | | | |
| | Homo-PP-2 | 44.8 | 7.5 | | | | | | |
| | Homo-PP-3 | 41.6 | 13 | | | | | | |
| | Post-added rubber | Ethylene-1-octene copolymer | | 4.3 | 3.6 | 1.8 | 3.0 | 2.6 | 3.0 |
| | Filler-1 | Talc | | 17.0 | 13.9 | 13.7 | 11.8 | 10.3 | 11.8 |
| | Filler-2 | Fibrous magnesium sulfate | | 8.7 | 7.1 | 7.0 | 6.1 | 5.3 | 6.1 |
| | Lubricant | Erucic acid amide, compatibilizer | | 2.2 | 1.8 | 1.8 | 1.5 | 1.3 | 1.5 |
| | | (erucic acid amide only) | | (0.44) | (0.36) | (0.36) | (0.30) | (0.26) | (0.30) |
| | Other Additives | Antioxidant, UV absorber, etc. | | 6.5 | 5.4 | 5.3 | 4.5 | 3.9 | 45 |
| Content (part) by mass) of rubber | | | | 54.4 | 48.6 | 46.7 | 44.5 | 41.6 | 46.4 |
| Content (part by mass) of filler | | | | 25.7 | 21.0 | 20.7 | 17.9 | 15.6 | 17.9 |
| Measured content (part by mass) of rubber | | | | 53.5 | 47.7 | 45.7 | 43.0 | 39.1 | 47.3 |
| Measured content of rubber/content of PP | | | | 0.389 | 0.436 | 0.421 | 0.475 | 0.511 | 0.550 |
| Physical | Measured weight average molecular | | | 44.2 | 40.3 | 40.3 | 37.9 | 35.5 | 33.1 |
| properties | weight Mw [×10⁴] | | | | | | | | |
| | Calculated weight average molecular | | | 45 | 42 | 42 | 39 | 36 | 35 |
| | weight Mw [×10⁴] | | | | | | | | |
| | Tensile yield | [MPa] | | 25.6 | 24.1 | 24.5 | 22.0 | 20.4 | 20.8 |
| | strength | | | | | | | | |
| | Tensile modulus | [MPa] | | 2441 | 2409 | 2487 | 2110 | — | 2075 |
| | Charpy impact | [kJ/m²] | | 35.6 | 39.6 | 36.7 | 46.1 | 44.8 | 38.8 |
| | strength | | | | | | | | |
| | Rockwell hardness | [N] | | 74 | 66 | 66 | 64 | 57 | 64 |
| | Whitening load | | | 7.1 | 5.3 | 7.2 | 5.8 | 4.4 | 54 |
| | MFR | [g/10 min] | | 6.2 | 9.3 | 10.6 | 12.5 | — | 20.8 |
| | | | | | Example | Comparative | Comparative | Comparative | Comparative |
| | | | Mw [×10⁴] | MFR | 7 | Example 1 | Example 2 | Example 3 | Example 4 |
| | Blending | Block PP-1 (rubber | 33 | 28 | 100 | 100 (37.0) | 100 (37.0) | 100 (37.0) | 100 (37.0) |
| | (part by | component: 37%) | | | (37.0) | | | | |
| | mass) | Block PP-2 (rubber | 59.3 | 2.5 | | | | | |
| | | component: 15%) | | | | | | | |
| | | Block PP-3 (rubber | Estimated | 9.5 | | | | | |
| | | component: 21%) | as 43 | | | | | | |
| | | Block PP-4 (rubber | 31.9 | 30 | | | | 30.3 (3.3) | |
| | | component: 11%) | | | | | | | |
| | | Homo-PP-1 | Estimated | 1.9 | 30.3 | | | | |
| | | | as 60 | | | | | | |
| | | Homo-PP-2 | 44.8 | 7.5 | | 30.3 | | | |
| | | Homo-PP-3 | 41.6 | 13 | | | 30.3 | | |

| | Post-added rubber | Ethylene-1-octene | 3.0 | 3.0 | 3.0 | 3.0 | 1.1 |
|---|---|---|---|---|---|---|---|
| | | copolymer | | | | | |
| | Filler-1 | Talc | 11.8 | 11.8 | 11.8 | 11.8 | 9.0 |
| | Filler-2 | Fibrous magnesium | 6.1 | 6.1 | 6.1 | 6.1 | 4.6 |
| | | sulfate | | | | | |
| | Lubricant | Erucic acid amide, | 1.5 | 1.5 (0.30) | 1.5 (0.30) | 1.5 (0.30) | 0 (0) |
| | | compatibilizer (erucic | (0.30) | | | | |
| | | acid amide only) | | | | | |
| | Other Additives | Antioxidant, UV | 4.5 | 4.5 | 4.5 | 4.5 | 3.4 |
| | | absorber, etc. | | | | | |
| Content (part) by mass) of rubber | | | 40.0 | 40.0 | 40.0 | 43.3 | 38.1 |
| Content (part by mass) of filler | | | 17.9 | 17.9 | 17.9 | 17.9 | 13.6 |
| Measured content (part by mass) of rubber | | | 42.7 | 42.5 | 41.9 | 44.0 | 34.3 |
| Measured content of rubber/content of PP | | | 0.472 | 0.469 | 0.459 | 0.492 | 0.512 |
| Physical | Measured weight average | | 38.8 | 34.9 | 33.7 | 32.7 | 32.5 |
| properties | molecular weight Mw [×10⁴] | | | | | | |
| | Calculated weight average | | 39 | 36 | 35 | 33 | 33.0 |
| | molecular weight Mw [×10⁴] | | | | | | |
| | Tensile yield | [MPa] | 24.4 | 22.8 | 22.3 | 21.0 | 19.2 |
| | strength | | | | | | |
| | Tensile modulus | [MPa] | 2309 | — | — | — | — |
| | Charpy impact | [kJ/m²] | 27.8 | 11.8 | 6.6 | 8.5 | 28.2 |
| | strength | | | | | | |
| | Rockwell hardness | [N] | 66 | 79 | 80 | 73 | 56.0 |
| | Whitening load | | 6.3 | 3.3 | 4.6 | 1.1 | 1.2 |
| | MFR | [g/10 min] | 12.6 | — | — | — | — |

Here, details of each material used are as follows.
Block PP-1: “PM970A” (trade name) from SunAllomer Ltd., rubber component 37 mass %, Mw 330,000, MFR 28 g/10 min, tensile yield strength 21 MPa, Charpy impact strength 34 kJ/m².
Block PP-2: “BC6C” (trade name) from Japan Polypropylene Corporation, rubber component 15 mass %, Mw 593,000, MFR 2.5 g/10 min, tensile yield strength 32 MPa, Charpy impact strength 10 kJ/m².
Block PP-3: “PM761A” (trade name) from SunAllomer Ltd., rubber component 21 mass %, Mw 430,000 (estimated value), MFR 9.5 g/10 min, tensile yield strength 25 MPa, Charpy impact strength 9.3 kJ/m².
Block PP-4: “BC03C” (trade name) from Japan Polypropylene Corporation, rubber component 11 mass %, Mw 319,000, MFR 30 g/10 min, tensile yield strength 33 MPa, Charpy impact strength 5.5 kJ/m².
Homo-PP-1: “EA6A” (trade name) from Japan Polypropylene Corporation, Mw 600,000 (estimated value), MFR 1.9 g/10 min, tensile yield strength 40 MPa, Charpy impact strength 3.5 kJ/m².
Homo-PP-2: “PM600D” (trade name) from SunAllomer Ltd., Mw 448,000, MFR 7.5 g/10 min, tensile yield strength 39 MPa, Charpy impact strength 3.9 kJ/m².
Homo-PP-3: “PM801A” (trade name) from SunAllomer Ltd., Mw 416,000, MFR 13 g/10 min, tensile yield strength 37 MPa, Charpy impact strength 3.5 kJ/m².

In the above details, the Charpy impact strength is a value at 23 °C. The rubber component was measured by pulse NMR (minispec mq20 from Bruker, Solid Echo method, observation nucleus: ¹H, measurement temperature: 30 °C, acquisition scale: 0.5 ms, Scans: 32), and fitting was performed assuming one component with fast molecular motion (Weibull coefficient W=1) and two components with slow molecular motion (each W=2), for a total of three components, and a ratio of the component with fast molecular motion to the three components was taken as the proportion of the rubber component.
Post-added rubber: “ENGAGE 8842” (trade name) from Dow Chemical Company, which is an ethylene-1-octene copolymer.
Filler-1: “MAT823T” (trade name) from SHIRAISHI CALCIUM KAISHA, LTD., which is talc.
Filler-2: “MOS-HIGE” (trade name) from Ube Material Industries, Ltd., which is fibrous basic magnesium sulfate.
Lubricant: erucic acid amide and a compatibilizer (a copolymer of ethylene and at least one vinyl monomer).
Antioxidant: “Irganox 1010” and “Irgafos 168” (trade name) from BASF.
UV absorber: “Tinuvin 326” (trade name) from BASF.

The “content of rubber” in Table 1 is a total of the rubber component copolymerized with the block polypropylene (based on the mass % of the rubber component indicated in each product) and the post-added rubber.

The “measured content of rubber” is a measured value of the content of the rubber actually measured by the applicant of the present application (more specifically, a total of a measured value of the content of non-extracted rubber and a measured value of the content of extracted rubber).

The content of PP (content of polypropylene) in the “measured content of rubber/content of PP” is a value obtained by subtracting the measured content of the rubber and the content of other materials from a total amount.

The “content of filler” is a total of the filler-1 and the filler-2.

The polypropylene compositions of Examples 1 to 7 and Comparative Examples 1 to 4 were kneaded and extruded by a kneading extruder, and then injected into a flat cavity of a mold by an injection molding machine to form plate-shaped molded articles. Plate-shaped test pieces of predetermined dimensions according to measurements were cut out from the molded articles, and the following physical properties were measured.

### <1> Weight Average Molecular Weight

The weight average molecular weight Mw of the polypropylene was measured using high-temperature gel permeation chromatography (GPC). Ortho-dichlorobenzene was used as a mobile phase at a flow rate of 0.3 mL/min and a measurement temperature of 140 °C. Columns used were Styragel HT6E, HT4, and HT3 from Waters connected together, and the measurement was carried out with an RI detector, after which a polystyrene equivalent value was calculated.

Note that Table 1 also shows the calculated Mw (an average value by mass ratio of Mw of two types of polypropylene). Due to similarity between the measured Mw and the calculated Mw in Example 1, the measured Mw in Examples 2 to 7 can also be estimated from their calculated values thereof to be in a range of 300,000 to 500,000.

In the prior application (Japanese Patent Application No. 2025-080657) on which the present application claims priority, the high-temperature GPC broke down and became unusable after measuring Mw of Example 1, making it impossible to measure Mw of Examples 2 to 7 and Comparative Examples 1 to 4. Therefore, Table 1 lists only the measured Mw of Example 1 (43× 10⁴) and the above estimation was made.

In the present application, Mw of Example 1 was measured again using another high-temperature GPC, which is an equivalent device, and Mw of Examples 2 to 7 and Comparative Examples 1 to 4 were also measured. These measured values are shown in Table 1, and it became clear that the above estimation is valid. A difference between the remeasured Mw (44× 10⁴) of Example 1 and the measured value in the above-mentioned prior application is believed to be due to variations between the devices.

### <2> Tensile Yield Strength and Tensile Modulus

In accordance with ISO 527:2012, an ISO No. 1 dumbbell test piece was prepared by the above-described injection molding and cutting, and the tensile yield strength was measured at a temperature of 23 °C and a test speed of 50 mm/min, and the tensile modulus was measured at a tensile speed of 1 mm/min.

### <3> Charpy Impact Strength

In accordance with ISO 179:2020, a notched test piece (length: 80 mm×width: 10 mm× thickness: 4 mm, notch depth: 2 mm, notch R: 0.25 mm) was prepared by the above-described injection molding and cutting, and was subjected to a Charpy impact test with a 2 J hammer at a temperature of 23 °C to measure the Charpy impact strength.

### <4> Rockwell Hardness

Rockwell hardness (23 °C, R scale) was measured in accordance with JIS K7202-2:2001.

### <5> Whitening Load

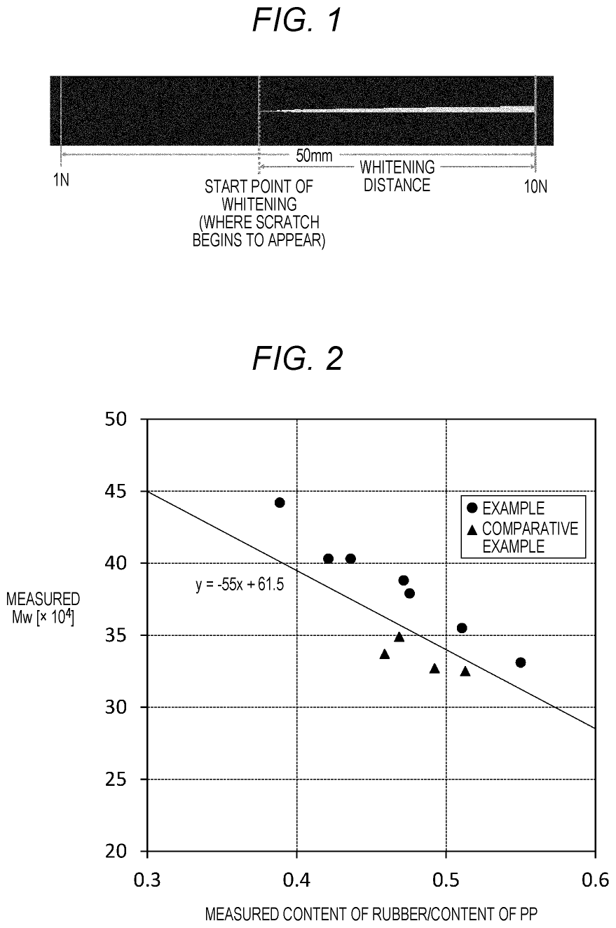

Using a device (scratch tester KK02 from Kato Tech Co., Ltd.) capable of performing the test method (linear force increase) specified in JIS K7316:2013, a test force was applied in the same manner as in the linear force increase method, with a total scratch distance set to 50 mm, a test force range set to 1 N to 10 N, and a test speed set to 50 mm/s. A test force, that is, a load (whitening load), at which the test piece began to whiten was determined as follows. As illustrated in FIG. 1, appearance of the test piece after loading was observed using a scanner attached to the device, and a distance of a whitened part from a start point of whitening (whitening distance) was measured using binarization processing, and the whitening load was calculated using the following formula.

Whitening load (N)=(50 mm-whitening distance)/50 mm×(10 N−1 N)+1 N

### <6> MFR

MFR was measured in accordance with ISO 1133:2011 at a temperature of 230 °C and a load of 21.2 N.

These measurement results are shown in Table 1.

Comparative Examples 1 to 4 have a Charpy impact strength of less than 20 kJ/m², or a whitening load of less than 4 N, or have both.

In contrast, Examples 1 to 7 have a Charpy impact strength of 20 kJ/m² or more, and a whitening load of 4 N or more.

Especially, Examples 1 to 6 are more preferable examples in that the Charpy impact strengths thereof are 20 kJ/m² or more.

Examples 1 to 4, 6 and 7 are more preferable examples in that the whitening loads thereof are 4 N or more.

Examples 2 to 7 are more preferable examples in that MFR thereof are 8 g/10 min or more.

Furthermore, Examples 1 to 7 satisfy the following formula (1) (see Table 1 and FIG. 2). As a result, the Charpy impact strengths thereof are 20 kJ/m² or more and the whitening loads thereof are 4 N or more.

Y≥−55X+61.5 (1)
where X represents a measured content of the rubber/a content of the polypropylene, and

Y represents a weight average molecular weight Mw [×10⁴] of the polypropylene.

Note that, the present invention is not limited to the aforementioned examples and can be appropriately modified and carried out within a scope that does not deviate from the spirit of the invention.

What is claimed is:

1. A polypropylene composition comprising:
a low-molecular-weight polypropylene which is a block polypropylene or a homo-polypropylene having a weight average molecular weight of 200,000 to 380,000;
a high-molecular-weight polypropylene which is a block polypropylene having a weight average molecular weight of 400,000 to 700,000 or a homo-polypropylene having a weight average molecular weight of 500,000 to 700,000; and
at least one rubber selected from a rubber component copolymerized with the low-molecular-weight polypropylene, a rubber component copolymerized with the high-molecular-weight polypropylene, and a post-added rubber.

2. The polypropylene composition according to claim 1, wherein
relative to 100 parts by mass of the low-molecular-weight polypropylene, an amount of the high-molecular-weight polypropylene is 6 parts by mass to 165 parts by mass, an amount of the rubber is 30 parts by mass to 70 parts by mass, and an amount of the filler is 0 part by mass to 40 parts by mass.

3. The polypropylene composition according to claim 1, wherein
the filler contains talc and fibrous magnesium sulfate.

4. A polypropylene composition comprising:
a polypropylene having a weight average molecular weight of 300,000 to 500,000;
a rubber; and
a filler containing at least talc, wherein
the polypropylene composition has a Charpy impact strength, at 23 °C, of 20 kJ/m² or more and a whitening load, which is a load at which a test piece begins to whiten when a test force is applied to the test piece based on a linear force increasing method in JIS K7316:2013, of 4 N or more.

5. The polypropylene composition according to claim 4, which has a tensile modulus, at 23 °C, of 1800 MPa or more.

6. The polypropylene composition according to claim 4, which has a Rockwell hardness, at 23 °C and on R scale, of 55 or more.

7. The polypropylene composition according to claim 4, which has a melt flow rate, at 230 °C and under a load of 21.2 N, of 5 g/10 min or more.

8. A polypropylene composition comprising:
a polypropylene;
a rubber; and
a filler containing at least talc, wherein
the polypropylene composition satisfies the following formula (1):
Y≥−55X+61.5 (1)
where X represents a measured content of the rubber/a content of the polypropylene, and
Y represents a weight average molecular weight of the polypropylene in units of ×10⁴.

9. A molded article molded from the polypropylene composition according to claim 1.
